(19) United States
(12) Patent Application Publication
(10) Pub. No.: US 2026/0226956 A1
(43) Pub. Date: Aug. 6, 2026

(54) TUBULAR VIBRATION-DAMPING DEVICE

(71) Applicants: SUMITOMO RIKO COMPANY LIMITED, Komaki-shi (JP); TOYOTA JIDOSHA KABUSHIKI KAISHA, Toyota-shi (JP)

(72) Inventors: Yorishige SHIMIZU, Komaki-shi (JP); Naoki FURUMACHI, Komaki-shi (JP); Keita KAMIYA, Komaki-shi (JP); Koki MARUYAMA, Chiryu-shi (JP); Akihiro KOMIYAMA, Okazaki-shi (JP)

(73) Assignees: SUMITOMO RIKO COMPANY LIMITED, Komaki-shi (JP); TOYOTA JIDOSHA KABUSHIKI KAISHA, Toyota-shi (JP)

(21) Appl. No.: 19/393,691

(22) Filed: Nov. 19, 2025

(30) Foreign Application Priority Data
Jan. 31, 2025 (JP) 2025-015246

(51) Int. Cl. F16F 1/38; B60K 5/12

(52) U.S. Cl. CPC F16F 1/3835; B60K 5/1266

(57) ABSTRACT

A tubular vibration-damping device including an inner shaft member and an outer tube member including an outer flange connected by a rubber elastic body, and an axial stopper rubber protruding axially outward from the outer flange while extending circumferentially to limit an axial elastic deformation of the rubber elastic body by contact with a stopper contact surface. In the rubber elastic body, a high-spring direction and a low-spring direction are set to respective two axis-perpendicular directions perpendicular to each other. Portions of the axial stopper rubber opposed in the high-spring direction comprise first lowered parts with a small height that are not in contact with the stopper contact surface in a mounted state. Portions of the axial stopper rubber opposed in the low-spring direction comprise contact parts with a large height that are in contact with the stopper contact surface in the mounted state.

### INCORPORATED BY REFERENCE

The disclosure of Japanese Patent Application No. 2025-015246 filed on January 31, 2025 including the specification, drawings and abstract is incorporated herein by reference in its entirety.

### BACKGROUND ART

### Technical Field

The present disclosure relates to a tubular vibration-damping device for use in, for example, a sub-frame mount or a power unit mount of an automobile, or the like.

### Description of the Related Art

Conventionally, a tubular vibration-damping device has been known as one type of vibration damping device for an automobile. As shown in Japanese Unexamined Patent Publication No. JP-A-2013-047559, for example, such a tubular vibration-damping device includes an inner shaft member and an outer tube member connected by a main rubber elastic body, and is mounted between a main body and a sub-body, between a power unit and a body, or the like in a condition where a main mounting load (a support load) or a vibration load is input in the center axis direction.

### SUMMARY

Meanwhile, the tubular vibration-damping device as shown in JP-A-2013-047559 employs an axial stopper mechanism using an axial stopper rubber protruding from an outer flange part of the outer tube member in the axial direction. The axial stopper mechanism limits the amount of elastic deformation of the main rubber elastic body in the axial direction in cushioned fashion by the axial stopper rubber coming into contact with a stopper contact surface.

Besides, in such an axial stopper mechanism, the axial stopper rubber is in contact with the stopper contact surface from the beginning to mitigate striking noise and impact caused by striking of the axial stopper rubber and to adjust the axial spring characteristics in a supplementary manner.

However, confirmation by the present inventors has recognized a new problem that, with the tubular vibration-damping device of conventional construction, it is difficult to obtain the intended axial spring characteristics with sufficient durability if the axial stopper rubber is in contact with the stopper contact surface from the beginning.

It is therefore one object of the present disclosure to provide a tubular vibration-damping device of novel structure which is able to obtain the intended axial spring characteristics with sufficient durability, while mitigating striking noise and impact caused by striking of the axial stopper rubber, adjusting the axial spring characteristics in a supplementary manner, and the like.

In order to attain such an object, the present inventors have examined the tubular vibration-damping device with the conventional structure, and found that in the tubular vibration-damping device with the conventional structure, the protruding distal end of the axial stopper rubber is likely to wear unevenly, which causes susceptibility of the axial spring characteristics to early deterioration. Further examination revealed the new fact that the degree of wear of the protruding distal end of the axial stopper rubber differs greatly depending on the circumferential region. By focusing on this fact, the present inventors completed the present disclosure that is able to reduce or avoid the uneven wear of the protruding distal end of the axial stopper rubber.

Specifically, even in the tubular vibration-damping device in which the main load is input in the axial direction, axis-perpendicular vibrations perpendicular to the center axis is also input when mounted onto a vehicle. In many cases, such axis-perpendicular vibrations (the relative amounts of vibration displacement in the axis-perpendicular direction between the inner shaft member and the outer tube member) have a large input direction and a small input direction. Here, the present inventors discovered that in the axial stopper rubber, due to its specific shape extending in the circumferential direction, the degree of wear is maximized at the regions opposed to each other in the direction perpendicular to the maximum input direction of the axis-perpendicular vibration, and from there the degree of wear gradually decreases toward the opposite sides in the circumferential direction, and the degree of wear is minimized at the regions opposed to each other in the maximum input direction of the axis-perpendicular vibration. By focusing on this fact, the present inventors aimed at solving the durability problem caused by the contact wear of the stopper rubber described above.

Hereinafter, preferred embodiments for grasping the present disclosure will be described. However, each preferred embodiment described below is exemplary and can be appropriately combined with each other. Besides, a plurality of elements described in each preferred embodiment can be recognized and adopted as independently as possible, or can also be appropriately combined with any element described in other preferred embodiments. By so doing, in the present disclosure, various other preferred embodiments can be realized without being limited to those described below.

A first preferred embodiment provides a tubular vibration-damping device comprising: an inner shaft member; an outer tube member including an outer flange part at an axial end of the outer tube member; a main rubber elastic body connecting the inner shaft member and the outer tube member; and an axial stopper rubber protruding toward an axially outer side from the outer flange part such that by contact with a stopper contact surface, the axial stopper rubber limits in cushioned fashion an amount of elastic deformation of the main rubber elastic body in an axial direction, the axial stopper rubber extending in a circumferential direction of the outer flange part, wherein the main rubber elastic body has spring characteristics different from each other in two directions that are mutually perpendicular in an axis-perpendicular direction, with a high-spring direction and a low-spring direction being set to the respective two directions, portions of the axial stopper rubber that are opposed to each other in the high-spring direction comprise first lowered parts where a protrusion height of the axial stopper rubber is made small, the first lowered parts being not in contact with the stopper contact surface in a mounted state, and portions of the axial stopper rubber that are opposed to each other in the low-spring direction comprise contact parts where the protrusion height of the axial stopper rubber is made large, the contact parts being in contact with the stopper contact surface in the mounted state.

Since the axial stopper rubber extends in the circumferential direction, the deformation rigidity (ease of elastic deformation) with respect to input vibration in a specific axis-perpendicular direction differs at each circumferential region. Specifically, when comparing “each axial stopper rubber per unit length in the circumferential direction,” the direction in which each axial stopper rubber extends with respect to the input vibration in a specific axis-perpendicular direction differs. Therefore, each circumferential region of the axial stopper rubber has a different deformation rigidity from one another due to differences in “the direction in which the deformation-constrained surface by bonding to the outer flange part extends” and “the deformation-constrained direction due to the axial stopper rubber that continues in the circumferential direction” with respect to the vibration input direction. Besides, in the case where the high-spring direction and the low-spring direction with different spring characteristics are set to the main rubber elastic body in the respective two directions that are mutually perpendicular in the axis-perpendicular direction, the amount of relative displacement between the inner shaft member and the outer tube member with respect to the input vibration load in the axis-perpendicular direction is likely to be larger in the low-spring direction than in the high-spring direction in general. Therefore, in the tubular vibration-damping device structured following the present preferred embodiment, the portions of the axial stopper rubber that are opposed to each other in the low-spring direction, in which the amount of relative displacement between the inner shaft member and the outer tube member in the axis-perpendicular direction is likely to be large, are in contact with the stopper contact surface. On the other hand, the portions of the axial stopper rubber that are opposed to each other in the high-spring direction, in which the amount of relative displacement between the inner shaft member and the outer tube member in the axis-perpendicular direction is likely to be small, comprise the first lowered parts, and a state of contact with the stopper contact surface is avoided. With this configuration, in the portions of the axial stopper rubber that are opposed to each other in the low-spring direction, where the axis-perpendicular vibration is input in the radial direction and the wear due to input of the axis-perpendicular vibration is suppressed, the initial axial spring characteristics are exhibited by the axial stopper rubber being in contact with the stopper contact surface from the beginning. Meanwhile, in the portions of the axial stopper rubber that are opposed to each other in the high-spring direction, where the maximum axis-perpendicular vibration is input in the circumferential direction (the tangential direction) and the wear due to input of the maximum axis-perpendicular vibration is likely to be a problem, the axial stopper rubber is not in contact with the stopper contact surface, which effectively suppresses the wear of the axial stopper rubber due to input of the axis-perpendicular vibration. Thus, deterioration in durability caused by the wear of the axial stopper rubber can be reduced or prevented.

A second preferred embodiment provides the tubular vibration-damping device according to the first preferred embodiment, wherein the axial stopper rubber comprises a pair of divided stopper parts divided by a pair of the first lowered parts and each having a length of less than half a circumference, the pair of divided stopper parts extending with a same protrusion height and a same circumferential length as each other.

According to the tubular vibration-damping device structured following the present preferred embodiment, the axial stopper rubber is divided into the pair of divided stopper parts. This achieves improvement in followability to deformation with respect to input of the axis-perpendicular vibration at each divided stopper part having the length of less than half the circumference. Therefore, wear reduction can be expected in the pair of divided stopper parts that are circumferentially off the first lowered parts as well.

A third preferred embodiment disclosure provides the tubular vibration-damping device according to the first or second preferred embodiment, wherein the axial stopper rubber comprises a pair of divided stopper parts divided by a pair of the first lowered parts and each having a length of less than half a circumference, and the pair of divided stopper parts include respective second lowered parts located circumferentially off the portions of the axial stopper rubber that are opposed to each other in the low-spring direction, and the protrusion height of the axial stopper rubber is made small at the second lowered parts such that the second lowered parts are not in contact with the stopper contact surface in the mounted state.

According to the tubular vibration-damping device structured following the present preferred embodiment, the second lowered parts are located circumferentially off the portions of the axial stopper rubber that are opposed to each other in the low-spring direction. This makes it possible to more advantageously suppress the wear of the axial stopper rubber due to input of the axis-perpendicular vibration.

A fourth preferred embodiment provides the tubular vibration-damping device according to the third preferred embodiment, wherein the second lowered parts of the pair of divided stopper parts are located off the portions of the axial stopper rubber that are opposed to each other in the low-spring direction to a same side in the circumferential direction.

According to the tubular vibration-damping device structured following the present preferred embodiment, compared to the case where, for example, the second lowered parts are located off the portions of the axial stopper rubber that are opposed to each other in the low-spring direction to the different sides in the circumferential direction, the wear and the spring characteristics of the pair of divided stopper parts with respect to the axis-perpendicular vibration input are closer to each other. Therefore, it is possible to prevent uneven wear of only one of the pair of divided stopper parts and to achieve stabilization in vibration damping performance with respect to the axis-perpendicular vibration input.

A fifth preferred embodiment provides the tubular vibration-damping device according to any one of the first through fourth preferred embodiments, wherein the axial stopper rubber has a symmetrical shape in the axis-perpendicular direction with respect to a center axis.

According to the tubular vibration-damping device structured following the present preferred embodiment, the axial stopper rubber has a symmetrical shape in the axis-perpendicular direction with respect to the center axis. This enables stable vibration damping characteristics to be obtained with respect to the axis-perpendicular vibration input. Besides, when the axial stopper action is exhibited by the axial stopper rubber, the stopper load can be exerted in a balanced manner in the circumferential direction.

A sixth preferred embodiment provides the tubular vibration-damping device according to any one of the first through fifth preferred embodiments, wherein a contact member including the stopper contact surface is fixed to one axial end of the inner shaft member.

According to the tubular vibration-damping device structured following the present preferred embodiment, the contact member that is in contact with the axial stopper rubber is fixed to the inner shaft member connected with the outer tube member, which supports the axial stopper rubber, by the main rubber elastic body. This makes it possible to stabilize the contact state of the axial stopper rubber with the stopper contact surface, thereby readily achieving the desired spring and stopper characteristics.

A seventh preferred embodiment provides a structure in which a tubular vibration-damping device is mounted on a vehicle, the tubular vibration-damping device comprising: an inner shaft member; an outer tube member including an outer flange part at an axial end of the outer tube member; a main rubber elastic body connecting the inner shaft member and the outer tube member; and an axial stopper rubber protruding toward an axially outer side from the outer flange part and arranged in contact with a stopper contact surface such that the axial stopper rubber limits in cushioned fashion an amount of elastic deformation of the main rubber elastic body in an axial direction, the axial stopper rubber extending in a circumferential direction of the outer flange part, wherein a main load input direction with respect to the tubular vibration-damping device coincides with a center axis direction, the axial stopper rubber includes a plurality of lowered parts where a protrusion height of the axial stopper rubber is made small and are not in contact with the stopper contact surface in a mounted state, the plurality of lowered parts being spaced apart from each other in the circumferential direction while being arranged off portions of the axial stopper rubber that are opposed to each other in a maximum input direction of an axis-perpendicular vibration, and one pair of the plurality of lowered parts are opposed to each other in a direction perpendicular to the maximum input direction of the axis-perpendicular vibration.

With the structure in which the tubular vibration-damping device is mounted on the vehicle according to the present preferred embodiment, in the axial stopper rubber, the lowered parts are provided to the portions that are opposed to each other in the direction perpendicular to the diametrical direction in which the axis-perpendicular vibration is maximum, and a contact state of the axial stopper rubber is avoided at the portions forming the lowered parts. On the other hand, the axial stopper rubber is in contact with the stopper contact surface at the portions that are opposed to each other in the diametrical direction in which the axis-perpendicular vibration is maximum. With this configuration, the initial axial spring characteristics are exhibited by the axial stopper rubber being in contact with the stopper contact surface from the beginning. Besides, wear of the axial stopper rubber due to input of the axis-perpendicular vibration is effectively suppressed, thereby reducing or preventing deterioration in durability caused by the wear of the axial stopper rubber.

An eighth preferred embodiment provides a tubular vibration-damping device comprising: an inner shaft member; an outer tube member including an outer flange part at an axial end of the outer tube member; a main rubber elastic body connecting the inner shaft member and the outer tube member; an axial stopper rubber protruding toward an axially outer side from the outer flange part and arranged in contact with a stopper contact surface such that the axial stopper rubber limits in cushioned fashion an amount of elastic deformation of the main rubber elastic body in an axial direction, the axial stopper rubber extending in a circumferential direction of the outer flange part; and a directional indicator that visually represents a maximum input direction of an axis-perpendicular vibration in a mounted state on a vehicle, wherein the axial stopper rubber includes a plurality of lowered parts where a protrusion height of the axial stopper rubber is made small and are not in contact with the stopper contact surface, the plurality of lowered parts being spaced apart from each other in the circumferential direction, the plurality of lowered parts are all arranged off portions of the axial stopper rubber that are opposed to each other in the maximum input direction of the axis-perpendicular vibration identified by the directional indicator, and one pair of the plurality of lowered parts are opposed to each other in a direction perpendicular to the maximum input direction of the axis-perpendicular vibration identified by the directional indicator.

According to the tubular vibration-damping device structured following the present preferred embodiment, in the axial stopper rubber, the lowered parts are provided to the portions that are opposed to each other in the direction perpendicular to the maximum input direction of the axis-perpendicular vibration identified by the directional indicator, and a contact state of the axial stopper rubber is avoided at the portions forming the lowered parts. On the other hand, the axial stopper rubber is in contact with the stopper contact surface at the portions that are opposed to each other in the maximum input direction of the axis-perpendicular vibration. With this configuration, the initial axial spring characteristics are exhibited by the axial stopper rubber being in contact with the stopper contact surface from the beginning. Besides, wear of the axial stopper rubber due to input of the axis-perpendicular vibration is effectively suppressed, thereby reducing or preventing deterioration in durability caused by the wear of the axial stopper rubber.

According to the present disclosure, in the tubular vibration-damping device, it is possible to obtain the intended axial spring characteristics with sufficient durability, while mitigating striking noise and impact caused by striking of the axial stopper rubber, adjusting the axial spring characteristics in a supplementary manner, and the like.

### BRIEF DESCRIPTION OF THE DRAWINGS

The foregoing and/or other objects, features and advantages of the disclosure will become more apparent from the following description of a practical embodiment with reference to the accompanying drawings in which like reference numerals designate like elements and wherein:

FIG. 1 is a plan view of a tubular vibration-damping device according to a first practical embodiment of the present disclosure;

FIG. 2 is a front view of the tubular vibration-damping device shown in FIG. 1;

FIG. 3 is a cross sectional view taken along line 3-3 of FIG. 1;

FIG. 4 is a cross sectional view taken along line 4-4 of FIG. 1;

FIG. 5 is a plan view of the tubular vibration-damping device shown in FIG. 1 with an outer bracket mounted thereon;

FIG. 6 is a side view of the tubular vibration-damping device with the outer bracket shown in FIG. 5; and

FIG. 7 is a cross sectional view of the tubular vibration-damping device with the outer bracket of FIG. 5, which is shown in a mounted state on a suspension member.

### DETAILED DESCRIPTION

Hereinafter, a practical embodiment of the present disclosure will be described in reference to the drawings.

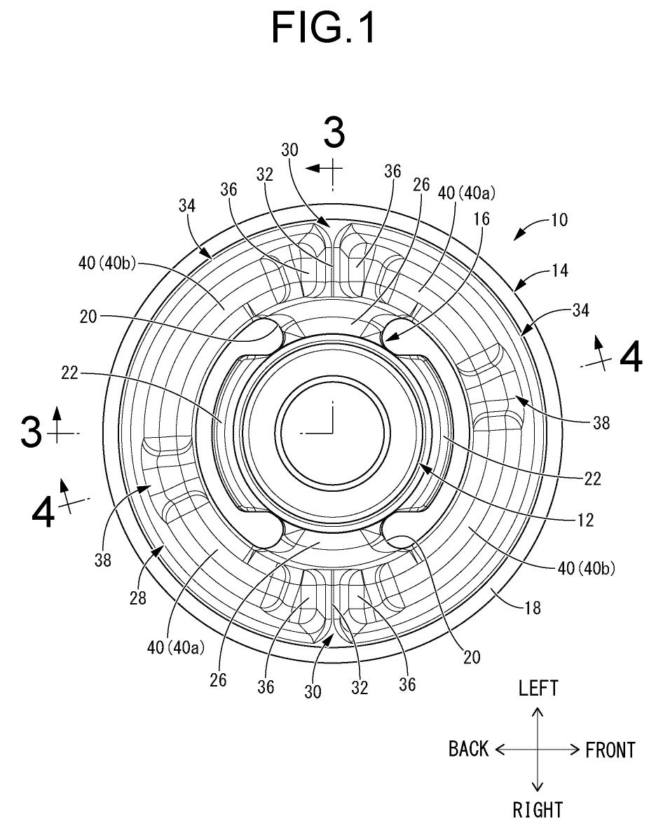

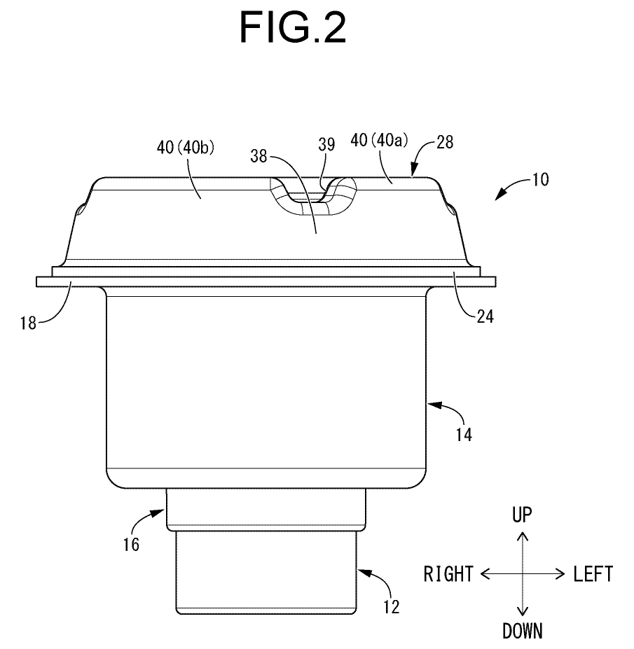

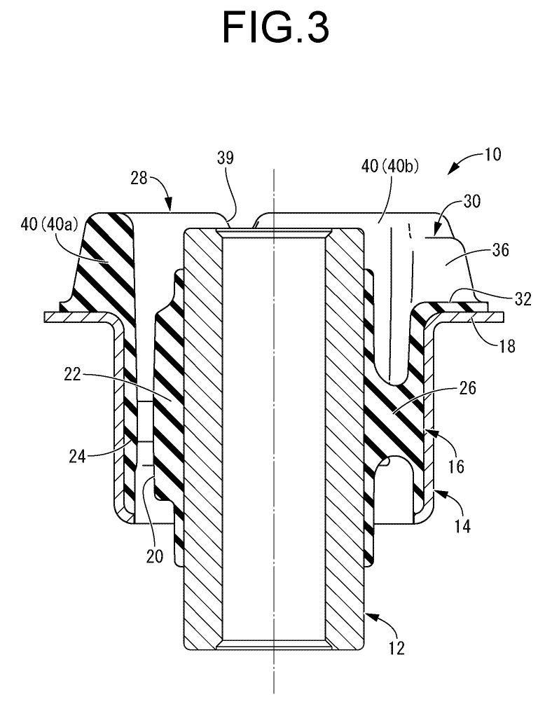

FIGS. 1 through 4 show a tubular vibration-damping device 10 according to a first practical embodiment of the present disclosure. The tubular vibration-damping device 10 has a structure in which an inner shaft member 12 and an outer tube member 14 are connected by a main rubber elastic body 16. In the following description, as a general rule, the vertical direction refers to the vertical direction in FIG. 2, which is the axial direction, the left-right direction refers to the vertical direction in FIG. 1, and the front-back direction refers to the left-right direction in FIG. 1.

The inner shaft member 12 has a thick-walled, small-diameter, cylindrical shape that extends linearly in the vertical direction. The inner shaft member 12 is a rigid member made of metal, fiber-reinforced synthetic resin, or the like.

The outer tube member 14 has a thin-walled, large-diameter, cylindrical shape overall. Like the inner shaft member 12, the outer tube member 14 is a rigid member formed of metal, fiber-reinforced synthetic resin, or the like. The outer tube member 14 is shorter in axial length than the inner shaft member 12. An outer flange part 18 spreading radially outward is integrally formed with the upper end, which is one axial end, of the outer tube member 14. The lower end, which is the other axial end, of the outer tube member 14, is bent to protrude radially inward.

The inner shaft member 12 is inserted through the outer tube member 14, and the main rubber elastic body 16 is disposed between the inner shaft member 12 and the outer tube member 14. The main rubber elastic body 16 has a thick-walled cylindrical shape overall, and its inner circumferential surface is bonded by vulcanization to the inner shaft member 12 while its outer circumferential surface is bonded by vulcanization to the outer tube member 14.

The main rubber elastic body 16 includes a pair of through holes 20, 20 on the opposite sides in the front-back direction with respect to the inner shaft member 12. Each through hole 20 passes through the main rubber elastic body 16 in the axial direction, and extends in the circumferential direction for a length of less than half the circumference. A radial stopper rubber 22 protrudes in the through hole 20. The radial stopper rubber 22 is integrally formed with the main rubber elastic body 16, and protrudes from the inner shaft member 12 toward the outer tube member 14 in the front-back direction, which is the low-spring direction. The radial stopper rubber 22, whose protruding distal end surface comprises a curved surface that is curved in the circumferential direction, is spaced apart radially inward from and opposed to a rubber sheath layer 24 covering the inner circumferential surface of the outer tube member 14.

A pair of rubber arm parts 26, 26 are formed circumferentially between the through holes 20, 20 of the main rubber elastic body 16. Each rubber arm part 26 extends in the left-right direction between the inner shaft member 12 and the outer tube member 14, and its inner end in the left-right direction is fastened to the inner shaft member 12 while its outer end in the left-right direction is fastened to the outer tube member 14. With this configuration, the inner shaft member 12 and the outer tube member 14 are elastically connected in the left-right direction by the pair of rubber arm parts 26, 26.

In the pair of rubber arm parts 26, 26 elastically connecting the inner shaft member 12 and the outer tube member 14 in the left-right direction, a compression spring component is dominant when a vibration load in the left-right direction is input across the inner shaft member 12 and the outer tube member 14, and a shear spring component is dominant when a vibration load in the front-back direction is input across the two members. Therefore, the tubular vibration-damping device 10 has high spring characteristics in the left-right direction and low spring characteristics in the front-back direction such that the spring characteristics are different in the left-right direction and in the front-back direction, with the left-right direction coinciding with a high-spring direction and the front-back direction coinciding with a low-spring direction.

The rubber sheath layer 24 covering the inner circumferential surface of the outer tube member 14 extends to the upper surface of the outer flange part 18 of the outer tube member 14. A bound stopper rubber 28 serving as an axial stopper rubber is integrally formed with the portion of the rubber sheath layer 24 that covers the upper surface of the outer flange part 18. The bound stopper rubber 28 protrudes from the outer flange part 18 toward the upper side, which is the axially outer side, and extends in the circumferential direction to form an approximately tubular shape overall. The bound stopper rubber 28 extends in the circumferential direction in a tapered cross-sectional shape that becomes narrower in the radial direction toward its protruding distal end.

The bound stopper rubber 28 includes a pair of first lowered parts 30, 30 where a protrusion height dimension is made small. The first lowered parts 30 are formed in the bound stopper rubber 28 at the respective portions that are opposed to each other in the left-right direction, which is the high-spring direction.

Regarding the bound stopper rubber 28 of the present practical embodiment, the protrusion height dimension is approximately zero at a dividing part 32 constituting the circumferential center portion of the first lowered part 30. Accordingly, the bound stopper rubber 28 is divided by the pair of first lowered parts 30, 30 into a front-and-back pair of divided stopper parts 34, 34. Each divided stopper part 34 extends in the circumferential direction with a length of less than half the circumference. The divided stopper part 34 extends in the circumferential direction with an approximately constant protrusion height at the portion off the first lowered part 30 and a second lowered part 38 described later. The pair of divided stopper parts 34, 34 have approximately the same circumferential length in the portion off the first lowered part 30 and the second lowered part 38 described later.

Stepped parts 36 that partially constitute the first lowered part 30 are provided on circumferentially opposite sides of the divided stopper part 34. At the stepped parts 36, the protrusion height dimension of the first lowered part 30 is made small. The stepped parts 36 are provided at circumferentially opposite ends of the first lowered part 30. The protrusion height dimension of the bound stopper rubber 28 at the stepped part 36 is smaller than the protrusion height dimension of the bound stopper rubber 28 at the portion off the first lowered part 30 and the second lowered part 38 described later, and larger than the protrusion height dimension of the bound stopper rubber 28 at the dividing part 32. The upper surface of the dividing part 32 and the upper surface of the stepped part 36 may be smoothly connected by a sloping surface so that the height dimension varies continuously. The first lowered part 30 including the dividing part 32 and the stepped parts 36, 36 is longer in circumferential length than the second lowered part 38 described later.

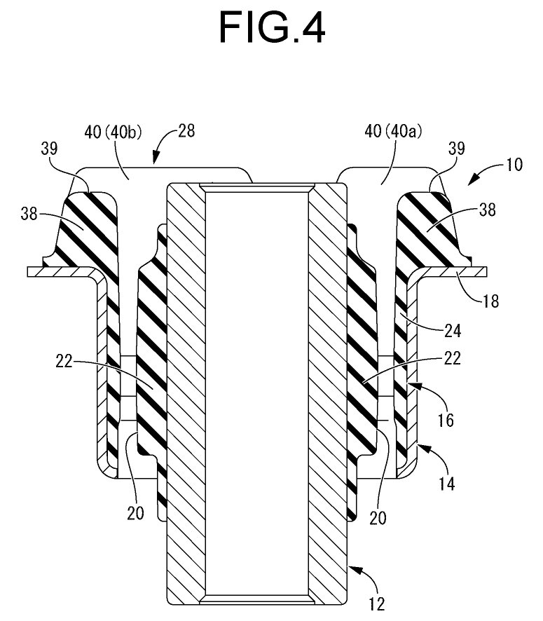

The divided stopper part 34 includes the second lowered part 38. As shown in FIG. 1, the second lowered part 38 is provided on a circumferential part of the divided stopper part 34, and has a protrusion height dimension smaller than that of the other portions (contact parts 40 described later) as shown in FIGS. 2 and 4. The pair of first lowered parts 30, 30 and the pair of second lowered parts 38, 38 are spaced apart from one another in the circumferential direction. At the portion forming the second lowered part 38 in the divided stopper part 34, there is provided a distal end recessed groove 39 opening onto the protruding distal end surface and penetrating the divided stopper part 34 in the radial direction. The second lowered part 38 is provided in each of the pair of divided stopper parts 34, 34, and the pair of second lowered parts 38, 38 are arranged in opposition to each other in the diametrical direction. The portions off the second lowered part 38 in the divided stopper part 34, in other words, the portions off the pair of first lowered parts 30, 30 and the pair of second lowered parts 38, 38 in the bound stopper rubber 28, comprise contact parts 40 where the protrusion height dimension of the bound stopper rubber 28 is made large. The bound stopper rubber 28 according to the present practical embodiment includes four contact parts 40, 40, 40, 40 in the circumferential direction.

The second lowered part 38 adjusts the spring characteristics of the divided stopper part 34 in the bound stopper rubber 28 in the axial direction. More specifically, the axial spring of the distal end portion of the divided stopper part 34 is reduced by the formation of the second lowered part 38.

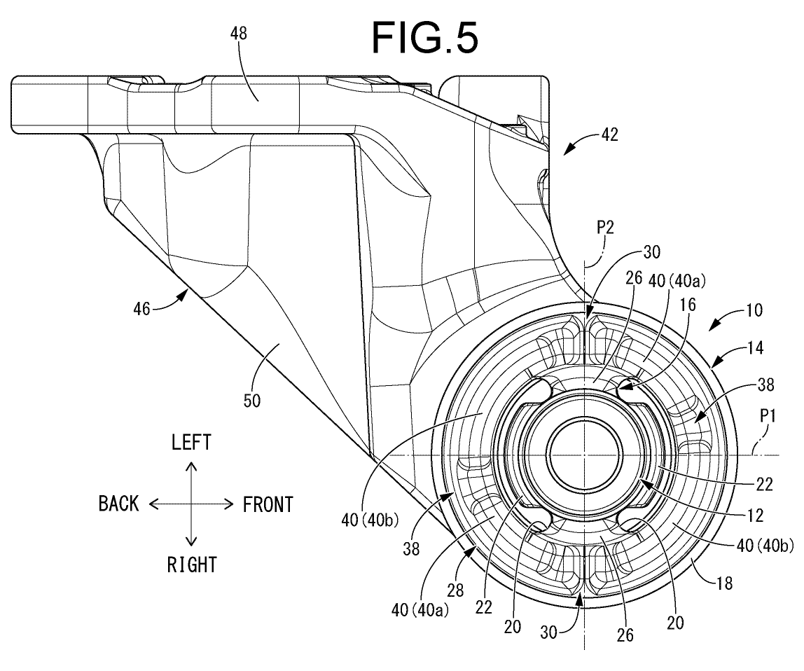

The pair of second lowered parts 38, 38 are located circumferentially off the portions of the bound stopper rubber 28 that are opposed to each other in the low-spring direction (the front-back direction) in the bound stopper rubber 28. Therefore, the portions of the bound stopper rubber 28 that are opposed to each other in the low-spring direction comprise the contact parts 40 with the large protrusion height. The pair of second lowered parts 38, 38 are located off the portions of the bound stopper rubber 28 that are opposed to each other in the low-spring direction to the same side and by the same distance in the circumferential direction, and are opposed to each other in the diametrical direction. Accordingly, the pair of divided stopper parts 34, 34 including the pair of second lowered parts 38, 38 are symmetrical in the axis-perpendicular direction with respect to the center axis of the outer tube member 14. That is, the pair of divided stopper parts 34, 34 including the pair of second lowered parts 38, 38 are rotationally symmetrical at 180 degrees about the center axis of the outer tube member 14. With the pair of second lowered parts 38,38 located circumferentially off the portions of the bound stopper rubber 28 that are opposed to each other in the low-spring direction, the divided stopper parts 34 have respective contact parts 40a with a shorter circumferential length and respective contact parts 40b with a longer circumferential length than the contact parts 40a, which constitute the portions of the bound stopper rubber 28 that are opposed to each other in the low-spring direction. The portions of the radial stopper rubbers 22 that are opposed to each other in the low-spring direction refer to the portions located on a plane P1 (see FIG. 5) extending in the front-back direction through the center axis of the outer tube member 14. Therefore, the locations that are circumferentially off the portions of the radial stopper rubber 22 that are opposed to each other in the low-spring direction refer to the locations that are off the plane P1 in the left-right direction.

Considering the overall characteristics of the bound stopper rubber 28 or the like, it is desirable that the difference in circumferential length between the contact parts 40a, 40b in the divided stopper part 34 that are circumferentially off the second lowered part 38 to the opposite sides is not excessively large, or it is desirable that the circumferential distance between the circumferentially adjacent lowered parts 30, 38 is not excessively small. Therefore, the distance for which each second lowered part 38 is circumferentially off the portions of the bound stopper rubber 28 that are opposed to each other in the low-spring direction is preferably short. In preferred practice, the distance for which each second lowered part 38 is circumferentially off the portions of the bound stopper rubber 28 that are opposed to each other in the low-spring direction is not greater than 1/50 of the circumferential length of the bound stopper rubber 28, for example. Besides, the contact parts 40a, 40b of the divided stopper part 34 preferably have a circumferential length ratio within a range of 1:0.3 to 1:0.8.

In the present practical embodiment, the pair of rubber arm parts 26, 26 extend in the left-right direction, which is the high-spring direction, while the pair of radial stopper rubbers 22, 22 protrude in the front-back direction, which is the low-spring direction. Therefore, the high-spring direction can be identified by the direction of extension of the pair of rubber arm parts 26, 26, and the low-spring direction can be identified by the direction of protrusion of the pair of radial stopper rubbers 22, 22.

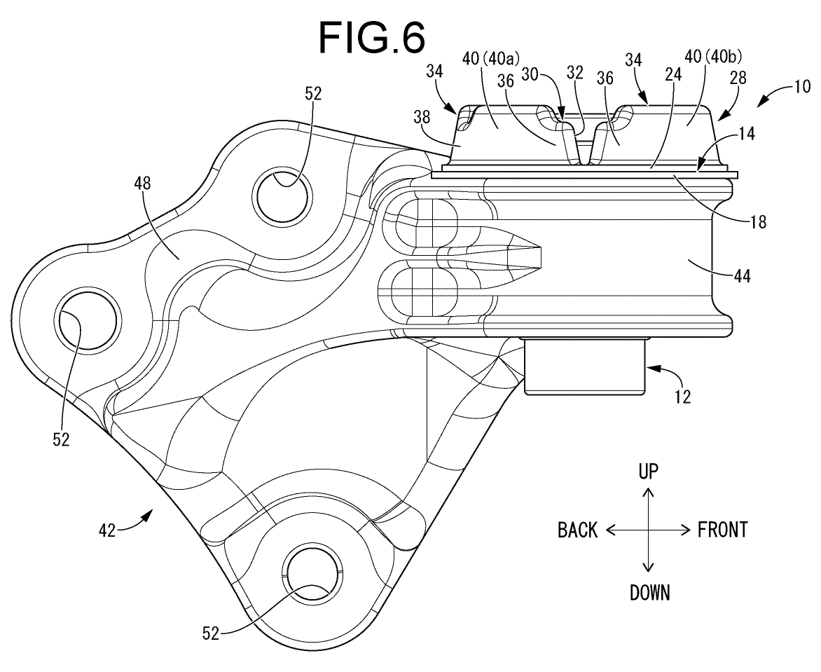

As shown in FIGS. 5 and 6, an outer bracket 42 is mounted onto the tubular vibration-damping device 10. The outer bracket 42 is a highly rigidity component made of a metal such as an aluminum alloy, a fiber-reinforced synthetic resin, or the like, and includes a mounting tubular part 44 to which the outer tube member 14 of the tubular vibration-damping device 10 is fixed by press-fitting. Besides, the outer bracket 42 includes a body fastening part 46 extending integrally from the outer circumferential surface of the mounting tubular part 44. The body fastening part 46 is not particularly limited in specific structure as long as it is fixed to a power unit described later with bolts or the like. In the present practical embodiment, the body fastening part 46 integrally includes a plate-shaped fixing part 48 that is fixed to the power unit (not shown), and a connecting part 50 that connects the fixing part 48 and the mounting tubular part 44. The fixing part 48 of the present practical embodiment is perforated by a plurality of bolt holes 52 in the plate thickness direction, and is fixed to the power unit by bolts (not shown) that are inserted through the bolt holes 52.

The tubular vibration-damping device 10 of the present practical embodiment is rotationally symmetrical at 180 degrees about the center axis overall. Thus, even if the outer tube member 14 is press-fitted into the mounting tubular part 44 of the outer bracket 42 in an orientation rotated 180 degrees around the center axis, the intended mounting condition can be achieved between the tubular vibration-damping device 10 and the outer bracket 42. That is, the outer bracket 42 may be mounted onto the tubular vibration-damping device 10 in the orientation in which the front in FIG. 1, which shows the tubular vibration-damping device 10 in isolation, is located in the back in FIG. 5, which shows the mounted state to the outer bracket 42, and the back in FIG. 1 is located in the front in FIG. 5, while the left in FIG. 1 is located on the right in FIG. 5, and the right in FIG. 1 is located on the left in FIG. 5.

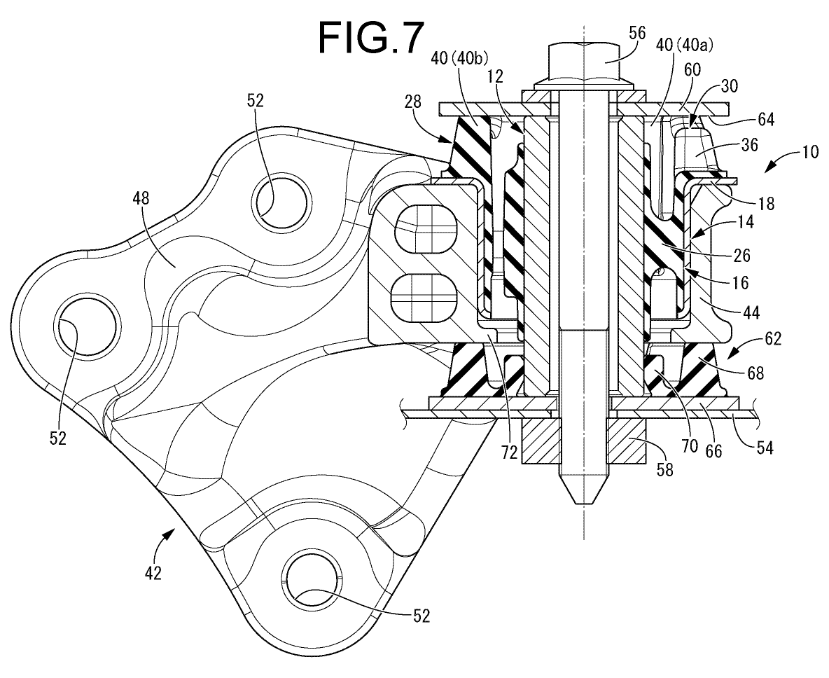

As shown in FIG. 7, with the outer bracket 42 mounted on the tubular vibration-damping device 10, the inner shaft member 12 is attached to a suspension member 54 constituting a vehicle. The inner shaft member 12 is fixed to the suspension member 54 by a fastening bolt 56 penetrating in the axial direction and a fastening nut 58 screwed thereto. FIG. 7 shows a structure in which the tubular vibration-damping device 10 is mounted on the vehicle, although the illustration of the power unit is omitted.

When fixing the inner shaft member 12 to the suspension member 54, a stopper plate 60 serving as a contact member is attached to one axial side of the inner shaft member 12. The stopper plate 60 has an approximately annular disk shape, and with its radially inner portion overlapped on the axially upper end surface of the inner shaft member 12, the stopper plate 60 is fixed to the inner shaft member 12 by the fastening bolt 56.

In the stopper plate 60 attached to the inner shaft member 12, its radially outer portion protrudes radially outward with respect to the inner shaft member 12, and the lower surface of the said radially outer portion comprises a stopper contact surface 64 overlapped on the protruding distal end surface of the bound stopper rubber 28. The stopper contact surface 64 of the stopper plate 60 is overlapped on the bound stopper rubber 28 in contact with the bound stopper rubber 28 at the portions (the contact parts 40) that are circumferentially off the pair of first lowered parts 30, 30 and the pair of second lowered parts 38, 38. The bound stopper rubber 28 is axially compressed at the contact parts 40 between the opposed faces of the stopper plate 60 and the outer flange part 18 of the outer tube member 14.

The pair of first lowered parts 30, 30 of the bound stopper rubber 28 are not in contact with the stopper contact surface 64 of the stopper plate 60, and are spaced apart downward from the stopper plate 60. Therefore, the bound stopper rubber 28 is not axially compressed at the pair of first lowered parts 30, 30 between the opposed faces of the outer flange part 18 of the outer tube member 14 and the stopper plate 60.

The pair of second lowered parts 38, 38 of the bound stopper rubber 28 are not in contact with the stopper contact surface 64 of the stopper plate 60, and are spaced apart downward from the stopper plate 60. Therefore, the bound stopper rubber 28 is not axially compressed at the pair of second lowered parts 38, 38 between the opposed faces of the outer flange part 18 of the outer tube member 14 and the stopper plate 60.

In the structure in which the tubular vibration-damping device 10 is mounted on the vehicle, the pair of first lowered parts 30, 30 and the pair of second lowered parts 38, 38 are all arranged circumferentially off the maximum input direction of the axis-perpendicular vibration. The maximum input direction of the axis-perpendicular vibration is the front-back direction in FIG. 5. The first lowered parts 30, 30 and the second lowered parts 38, 38 are all circumferentially off the plane P1 (see FIG. 5) that spreads in the front-back direction through the center axis of the tubular vibration-damping device 10 mounted on the vehicle. The maximum input direction of the axis-perpendicular vibration is approximately the same direction as the low-spring direction of the tubular vibration-damping device 10 mounted on the vehicle.

The tubular vibration-damping device 10 is mounted onto the vehicle in an orientation in which the pair of first lowered parts 30, 30 are opposed to each other in the direction approximately perpendicular to the maximum input direction of the axis-perpendicular vibration. That is, the pair of first lowered parts 30, 30 are arranged on the left and right opposite sides, and are located on a plane P2 that is perpendicular to the plane P1 on the center axis of the tubular vibration-damping device 10 and spreads in the axis-perpendicular direction. The plane P2, which is a plane perpendicular to the maximum input direction of the axis-perpendicular vibration, extends and spreads in approximately the same direction as the high-spring direction of the tubular vibration-damping device 10 mounted on the vehicle.

With the tubular vibration-damping device 10 mounted on the vehicle, the pair of first lowered parts 30, 30 are opposed to each other in the direction approximately perpendicular to the maximum input direction of the axis-perpendicular vibration. Thus, in the isolated state of the tubular vibration-damping device 10 before mounting onto the vehicle, by visually observing the pair of first lowered parts 30, 30, it is possible to grasp the maximum input direction of the axis-perpendicular vibration in the mounted state on the vehicle. In this way, in the present practical embodiment, the pair of first lowered parts 30, 30 comprise a directional indicator that, in the isolated state of the tubular vibration-damping device 10, visually represents the maximum input direction of the axis-perpendicular vibration in the structure in which the tubular vibration-damping device 10 is mounted on the vehicle. The maximum input direction of the axis-perpendicular vibration with the tubular vibration-damping device 10 mounted on the vehicle is identified by the pair of first lowered parts 30, 30, which comprise the directional indicator, in the isolated state of the tubular vibration-damping device 10. Thus, by using the pair of first lowered parts 30, 30 as reference locations, the circumferential locations of the other lowered parts (the pair of second lowered parts 38, 38 in the present practical embodiment) can be set, thereby making it possible to arrange all the plurality of lowered parts circumferentially off the maximum input direction of the axis-perpendicular vibration with the tubular vibration-damping device 10 mounted on the vehicle.

When fixing the inner shaft member 12 to the suspension member 54, a stopper member 62 is attached to the other axial side of the inner shaft member 12. The stopper member 62 includes a substrate 66 fixed to the inner shaft member 12, and a rebound stopper rubber 68 fastened to the substrate 66. The substrate 66 has an approximately annular disk shape and is fixed to the inner shaft member 12 by the fastening bolt 56 and the fastening nut 58 with its radially inner portion overlapped on the other axial end surface of the inner shaft member 12. The substrate 66 protrudes radially outward with respect to the inner shaft member 12 in the mounted state on the inner shaft member 12.

The rebound stopper rubber 68 is fastened to the radially outer portion of the substrate 66, and protrudes upward from the substrate 66. The rebound stopper rubber 68 has a cylindrical shape overall, and has a cross-sectional shape that becomes narrower in the radial direction toward the protruding distal end side (the upper side). On the radial inside of the rebound stopper rubber 68, a tubular positioning rubber 70 is provided. The positioning rubber 70 is integrally formed with the rebound stopper rubber 68, and the axial end of the inner shaft member 12 can be inserted into its radial inside.

Regarding the stopper member 62, with the radially inner portion of the substrate 66 overlapped on the other axial end surface (the lower end surface) of the inner shaft member 12 from below, the inner shaft member 12 is fixed by bolting with the fastening bolt 56 and the fastening nut 58 to the suspension member 54. By so doing, the radially inner portion of the substrate 66 is fixed to the inner shaft member 12 and the suspension member 54. In the present practical embodiment, the lower surface of the substrate 66 is overlapped on the suspension member 54. By the insertion of the lower end of the inner shaft member 12 into the radial inside of the positioning rubber 70, the stopper member 62 is positioned to some extent with respect to the inner shaft member 12 before fixing with the bolt.

With the stopper member 62 attached to the inner shaft member 12, the rebound stopper rubber 68 is butted against the lower end surface of the mounting tubular part 44 of the outer bracket 42, and the rebound stopper rubber 68 is compressed in the axial direction between the opposed faces of the substrate 66 and the mounting tubular part 44. The mounting tubular part 44 in the present practical embodiment includes an inner flange-shaped part 72 protruding radially inward at the lower end, thereby ensuring a wider contact surface for the rebound stopper rubber 68 in the radial direction. Here, the positioning rubber 70 has an axial protrusion height dimension smaller than that of the rebound stopper rubber 68, and is not compressed in the axial direction.

Regarding the tubular vibration-damping device 10 in the mounted state on the vehicle in which the inner shaft member 12 is attached to the suspension member 54 while the outer tube member 14 is attached to the power unit (not shown) via the outer bracket 42, the main load input direction coincides with the center axis direction. The vibration damping action exerted due to elastic deformation of the main rubber elastic body 16 suppresses transmission of vibration between the power unit and the suspension member 54.

In the structure in which the tubular vibration-damping device 10 is mounted on the vehicle, when axial vibration is input, the amount of relative displacement between the inner shaft member 12 and the outer tube member 14 in the bound direction is limited by contact between the outer flange part 18 of the outer tube member 14 and the stopper plate 60 via the bound stopper rubber 28. Besides, the amount of relative displacement between the inner shaft member 12 and the outer tube member 14 in the rebound direction is limited by contact between the mounting tubular part 44 of the outer bracket 42 and the substrate 66 of the stopper member 62 via the rebound stopper rubber 68. By so doing, the amount of relative displacement between the inner shaft member 12 and the outer tube member 14 in the axial direction is limited on the opposite sides, and the amount of elastic deformation of the main rubber elastic body 16 is limited in cushioned fashion. This prevents deterioration in durability due to excessive shear deformation of the main rubber elastic body 16.

The contact parts 40 off the first and second lowered parts 30, 38 in the bound stopper rubber 28 are in contact with the stopper plate 60 in advance. Therefore, compared to the case where the bound stopper rubber 28 and the stopper plate 60 strike against each other from a separated state, occurrence of striking noise or the like is prevented. Besides, the spring characteristics of the bound stopper rubber 28 can be adjusted with a large degree of freedom by pre-compression of the bound stopper rubber 28 in the axial direction. The bound stopper rubber 28 is spaced apart downward from the stopper plate 60 at the first and second lowered parts 30, 38.

The first lowered part 30 includes the dividing part 32, where the protrusion height dimension from the outer flange part 18 of the outer tube member 14 is made small, and the stepped parts 36, 36 with the protrusion height dimension larger than that of the dividing part 32, the stepped parts 36, 36 being provided on circumferentially opposite sides of the dividing part 32. When the input in the axial direction is large, the stepped part 36 comes into contact with the stopper plate 60 as the amount of compressive deformation of the bound stopper rubber 28 increases. Accordingly, the stopper action on the input in the bound direction changes in a stepwise manner, and the amount of relative displacement between the inner shaft member 12 and the outer tube member 14 in the bound direction is more reliably limited.

The second lowered part 38 has approximately the same protrusion height dimension as the stepped part 36 of the first lowered part 30. Like the stepped part 36 of the first lowered part 30, the second lowered part 38 comes into contact with the stopper plate 60 as the amount of compressive deformation of the bound stopper rubber 28 increases, thereby contributing to a stepwise change in stopper action.

The pair of second lowered parts 38, 38 are off to the same side in the circumferential direction with respect to the maximum input direction of the axis-perpendicular vibration. This allows the pair of divided stopper parts 34, 34 in the bound stopper rubber 28 to be close to a symmetrical shape with respect to the center axis, thereby stabilizing the embodiment of deformation of the bound stopper rubber 28 including the second lowered parts 38, 38. In the present practical embodiment in particular, the pair of first lowered parts 30, 30 are opposed to each other in the diametrical direction and the pair of second lowered parts 38, 38 are opposed to each other in the diametrical direction, so that the bound stopper rubber 28 has a symmetrical shape in the axis-perpendicular direction with respect to the center axis. With this configuration, the bound stopper rubber 28 deforms in a balanced manner during input of the axial vibration to exert a stable axial stopper action.

In the structure in which the tubular vibration-damping device 10 mounted on the vehicle, wear of the bound stopper rubber 28 is suppressed during vibration input in the axis-perpendicular direction. That is, when the maximum vibration in the axis-perpendicular direction is input in the front-back direction in FIG. 5, the contact parts 40 off the first and second lowered parts 38, 38 in the bound stopper rubber 28 are in contact with the stopper plate 60 in advance, so that sliding against the stopper plate 60 can occur.

Since the bound stopper rubber 28 extends in the circumferential direction, the degree of wear due to sliding differs at different circumferential locations. Specifically, in the portion located in the input direction of the axis-perpendicular vibration (on the plane P1), the axis-perpendicular input acts on the bound stopper rubber 28 in the radial direction. Thus, the bound stopper rubber 28 relatively easily deforms, and the protruding distal end portion of the bound stopper rubber 28 follows the stopper plate 60. Therefore, wear of the bound stopper rubber 28 due to rubbing against the stopper plate 60 is suppressed in the portion located in the input direction of the axis-perpendicular vibration. On the other hand, in the portion located in the direction perpendicular to the input direction of the axis-perpendicular vibration (on the plane P2), the axis-perpendicular input acts on the bound stopper rubber 28 in the circumferential direction (the tangential direction). Thus, the deformation rigidity of the bound stopper rubber 28 is high, and the protruding distal end portion of the bound stopper rubber 28 is unlikely to follow the stopper plate 60. Therefore, wear of the bound stopper rubber 28 due to rubbing against the stopper plate 60 is likely to occur in the portion located in the direction perpendicular to the input direction of the axis-perpendicular vibration.

Here, the portions of the bound stopper rubber 28 that are opposed to each other in the input direction of the axis-perpendicular vibration are off the first and second lowered parts 30, 38 and are in contact with the stopper plate 60 in advance. In this way, the portions of the bound stopper rubber 28 that are opposed to each other in the maximum input direction of the axis-perpendicular vibration, where wear is less likely to be a problem, are pressed against the stopper plate 60 in advance, thereby contributing to prevention of striking noise or the like, and tuning of the stopper characteristics.

Besides, the pair of first lowered parts 30, 30 are arranged on the portions of the bound stopper rubber 28 that are opposed to each other in the direction perpendicular to the input direction of the axis-perpendicular vibration, and the said portions of the bound stopper rubber 28 are not in contact with the stopper plate 60. This avoids wear of the bound stopper rubber 28 in the direction perpendicular to the maximum input direction of the axis-perpendicular vibration, where wear of the bound stopper rubber 28 due to rubbing against the stopper plate 60 is likely to be a problem.

In the present practical embodiment, the rebound stopper rubber 68 is in contact with the mounting tubular part 44 of the outer bracket 42 in advance. This also prevents striking noise or the like due to striking between the rebound stopper rubber 68 and the mounting tubular part 44. Besides, the spring characteristics of the rebound stopper rubber 68 can be adjusted with a large degree of freedom by pre-compression of the rebound stopper rubber 68 in the axial direction. The rebound stopper rubber 68 is separate from the main rubber elastic body 16, and a degree of freedom in selecting its rubber material is large. Thus, it is relatively easy to select a rubber material with superior wear resistance for the rebound stopper rubber 68 compared to the case for the bound stopper rubber 28, which is integrally formed with the main rubber elastic body 16, so that wear during input of axis-perpendicular vibration is less likely to be a problem. Of course, by providing the rebound stopper rubber 68 with the first lowered parts 30 and the second lowered parts 38 in the same way as the bound stopper rubber 28, it is also possible to improve wear resistance and achieve auxiliary adjustment of the spring characteristics.

A practical embodiment of the present disclosure has been described in detail above, but the present disclosure is not limited to those specific descriptions. For example, the first lowered part is not necessarily limited to the stepped shape having the stepped part 36 as described in the first practical embodiment. Besides, the first lowered part may include a plurality of stepped parts having different heights.

The first lowered part need not include a portion having a protrusion height dimension of approximately zero like the dividing part 32 described in the first practical embodiment. For example, the first lowered part may have a certain degree of protrusion height dimension overall, like the second lowered part 38.

It would also be acceptable to provide a plurality of second lowered parts to each divided stopper part. In this case, the plurality of second lowered parts may be the same or different in shape and size from each other. Also, the arrangement of the plurality of second lowered parts in the circumferential direction in the divided stopper part is not particularly limited.

The directional indicator need not necessarily be defined by the lowered parts, but may be defined by other structures such as, for example, the shapes of the inner shaft member, the outer tube member, and the main rubber elastic body. Specifically, for example, the directional indicator may be defined by a notch formed partially in the circumferential direction on the outer flange part of the outer tube member, or by the rubber arm part or the radial stopper rubber of the main rubber elastic body. It is also possible to additionally provide the directional indicator. For example, a marking may be provided as the directional indicator by concave and convex portions or coloring on the rubber arm part, the radial stopper rubber, the axial stopper rubber, the inner shaft member, the outer tube member, or the like. Furthermore, for example, it is also possible to utilize an injection gate trace, which is the trace of the gate through which a rubber material is injected into the mold during the molding of the main rubber elastic body, as the directional indicator.

The main rubber elastic body may, for example, have a cylindrical shape in which the portion other than the axial stopper rubber is continuous in the circumferential direction with an approximately constant cross-sectional shape. That is, the structure of the main rubber elastic body is not limited to the one including the through hole 20, the radial stopper rubber 22, and the rubber arm parts 26 like the main rubber elastic body 16 described in the first practical embodiment.

The tubular vibration-damping device according to the present disclosure is not limited to use for the vibration damping connection between the suspension member 54 and the power unit as illustrated in the first practical embodiment, but can also be used, for example, for a vibration damping connection between a subframe and a vehicle body, which is a mainframe.

What is claimed is:

1. A tubular vibration-damping device comprising:
an inner shaft member;
an outer tube member including an outer flange part at an axial end of the outer tube member;
a main rubber elastic body connecting the inner shaft member and the outer tube member; and
an axial stopper rubber protruding toward an axially outer side from the outer flange part such that by contact with a stopper contact surface, the axial stopper rubber limits in cushioned fashion an amount of elastic deformation of the main rubber elastic body in an axial direction, the axial stopper rubber extending in a circumferential direction of the outer flange part, wherein
the main rubber elastic body has spring characteristics different from each other in two directions that are mutually perpendicular in an axis-perpendicular direction, with a high-spring direction and a low-spring direction being set to the respective two directions,
portions of the axial stopper rubber that are opposed to each other in the high-spring direction comprise first lowered parts where a protrusion height of the axial stopper rubber is made small, the first lowered parts being not in contact with the stopper contact surface in a mounted state,
and
portions of the axial stopper rubber that are opposed to each other in the low-spring direction comprise contact parts where the protrusion height of the axial stopper rubber is made large, the contact parts being in contact with the stopper contact surface in the mounted state.

2. The tubular vibration-damping device according to claim 1, wherein the axial stopper rubber comprises a pair of divided stopper parts divided by a pair of the first lowered parts and each having a length of less than half a circumference, the pair of divided stopper parts extending with a same protrusion height and a same circumferential length as each other.

3. The tubular vibration-damping device according to claim 1, wherein
the axial stopper rubber comprises a pair of divided stopper parts divided by a pair of the first lowered parts and each having a length of less than half a circumference, and
the pair of divided stopper parts include respective second lowered parts located circumferentially off the portions of the axial stopper rubber that are opposed to each other in the low-spring direction, and the protrusion height of the axial stopper rubber is made small at the second lowered parts such that the second lowered parts are not in contact with the stopper contact surface in the mounted state.

4. The tubular vibration-damping device according to claim 3, wherein the second lowered parts of the pair of divided stopper parts are located off the portions of the axial stopper rubber that are opposed to each other in the low-spring direction to a same side in the circumferential direction.

5. The tubular vibration-damping device according to claim 1, wherein the axial stopper rubber has a symmetrical shape in the axis-perpendicular direction with respect to a center axis.

6. The tubular vibration-damping device according to claim 1, wherein a contact member including the stopper contact surface is fixed to one axial end of the inner shaft member.

7. A structure in which a tubular vibration-damping device is mounted on a vehicle, the tubular vibration-damping device comprising: an inner shaft member; an outer tube member including an outer flange part at an axial end of the outer tube member; a main rubber elastic body connecting the inner shaft member and the outer tube member; and an axial stopper rubber protruding toward an axially outer side from the outer flange part and arranged in contact with a stopper contact surface such that the axial stopper rubber limits in cushioned fashion an amount of elastic deformation of the main rubber elastic body in an axial direction, the axial stopper rubber extending in a circumferential direction of the outer flange part, wherein
a main load input direction with respect to the tubular vibration-damping device coincides with a center axis direction,
the axial stopper rubber includes a plurality of lowered parts where a protrusion height of the axial stopper rubber is made small and are not in contact with the stopper contact surface in a mounted state, the plurality of lowered parts being spaced apart from each other in the circumferential direction while being arranged off portions of the axial stopper rubber that are opposed to each other in a maximum input direction of an axis-perpendicular vibration, and
one pair of the plurality of lowered parts are opposed to each other in a direction perpendicular to the maximum input direction of the axis-perpendicular vibration.

8. A tubular vibration-damping device comprising:
an inner shaft member;
an outer tube member including an outer flange part at an axial end of the outer tube member;
a main rubber elastic body connecting the inner shaft member and the outer tube member;
an axial stopper rubber protruding toward an axially outer side from the outer flange part and arranged in contact with a stopper contact surface such that the axial stopper rubber limits in cushioned fashion an amount of elastic deformation of the main rubber elastic body in an axial direction, the axial stopper rubber extending in a circumferential direction of the outer flange part; and
a directional indicator that visually represents a maximum input direction of an axis-perpendicular vibration in a mounted state on a vehicle, wherein
the axial stopper rubber includes a plurality of lowered parts where a protrusion height of the axial stopper rubber is made small and are not in contact with the stopper contact surface, the plurality of lowered parts being spaced apart from each other in the circumferential direction,
the plurality of lowered parts are all arranged off portions of the axial stopper rubber that are opposed to each other in the maximum input direction of the axis-perpendicular vibration identified by the directional indicator, and
one pair of the plurality of lowered parts are opposed to each other in a direction perpendicular to the maximum input direction of the axis-perpendicular vibration identified by the directional indicator.
